(19) United States
(12) Patent Application Publication
(10) Pub. No.: US 2006/0237117 A1
(43) Pub. Date: Oct. 26, 2006

(54) Method of producing a retro-reflective product with a transparent protective film for whole surface

(76) Inventor: In-Hwan Lee, Pusan (KR)

Correspondence Address: NOTARO AND MICHALOS, 100 DUTCH HILL ROAD, SUITE 110, ORANGEBURG, NY, 10962-2100, US

(21) Appl. No.: 11/111,204

(22) Filed: Apr. 21, 2005

(51) Int. Cl. B32B 37/00; B32B 38/04

(52) U.S. Cl. 156/73.3; 156/235; 156/230; 156/250; 156/251

(57) ABSTRACT

A method of producing a retro-reflective product with protecting film includes forming a primary liquid layer for fixing a TPU sheet on glass beads of a base film made of a PET film, forming a secondary liquid layer for fixing the layer to backing material on the primary liquid layer and then producing a transfer film. A a semi-finished product is producted in which the glass beads are exposed by joining the backing material to the secondary liquid layer and then by separating the PET film from the PE resin layer, making the liquid on the primary liquid layer on both sides of the TPU sheet to which heat and pressure was applied pass through the gaps among the glass beads while the liquid PU is activated, so that the liquid is fixed to the transparent or semitransparent TPU sheet on top.

### BACKGROUND OF THE INVENTION

1. Technical Field

The present invention is related to a method of producing a retro-reflective product with a transparent protective film for the whole surface thereof, and, in particular, to a retro-reflective product excellent in physical durability, flexibility, secondary workability, change resistance, resistance to ultraviolet rays, water resistance, weather resistance, salt resistance, solvent resistance, etc. without lowering luminance.

2. Description of the Prior Art

A retro-reflective sheet is widely used for producing products, such as safety clothes, fire clothes, safety products, safety equipment, sportswear, shoes, decorations and the like. Thanks to its retro-reflection when it receives light, it can exhibit peculiar design while, because the glass bead layer is exposed on the surface, it lacks in physical durability, so that damages may be caused in the glass bead layer when friction or impact is applied to lower the capability of retro-reflection and to exhibit bad appearance, disadvantageously resulting in lower product quality.

The exposed glass beads causes bad change resistance and can be easily removed, and polluted by foreign matters such as dust or fume, etc., causing significantly lowered capability of retro-reflection. In such a case, it is not easy to clean the beads (the glass beads may be removed). Significantly reduced resistance to ultraviolet rays leads to bad capability of adhesion and retro-reflection, and also causes bad secondary workability so that its application to various products may be restricted. Additionally, when the recursively reflecting sheet is attached to different material (backing material) or the retro-reflective sheet to leather or rubber, the glass bead layer is easily separated because of its bad adhesion, thus causing products to be rejected and also product durability to be lowered. Therefore, to overcome the aforementioned problems, there is a continuous need for improving the disadvantages

### BRIEF SUMMARY OF THE INVENTION

It is an object of the present invention to settle and solve the aforementioned problems and disadvantages of conventional retro-reflective sheets and the invention is characterized by comprising the three steps of: producing a transfer film by forming a primary PU layer 4 for fixing a TPU sheet on the surface of the glass beads 3 of a conventional base film a consisting of a PET film 1, PE resin 2 and glass beads 3, and, at the same time, by forming a secondary liquid PU layer 5 for fixing the backing material subsequently on the primary liquid PU layer 4, in step 1; producing a semi-finished product in which the glass beads 3 are exposed by joining the secondary liquid PU layer 5 subject to the above step 1, to the backing material 6 and then subsequently separating the PET film 1 from the PE resin 2, in step 2; and placing a transparent or semitransparent TPU sheet 7 on the surface of the glass beads 3 of the semi-finished product subject to the above step 2, and then carrying out high-frequency molding and cutting by means of a high-frequency molding and cutting mold 8, so that, while the liquid PU on the primary liquid PU layer 4 placed on both sides of the TPU sheet 7a is activated to which heat and pressure was applied, the activated liquid PU passes through the gaps among the glass beads 3a thereby to be fixed to the transparent or semitransparent TPU sheet 7a on top.

The invention is also characterized by comprising the three steps of: producing a transfer film by forming a primary liquid PU layer 4 for fixing a TPU sheet on the surface of the glass beads 3 of a conventional base film a consisting of a PET film 1, PE resin 2 and glass beads 3, and, at the same time, by forming a secondary liquid PU layer 5 for fixing the backing material subsequently on the primary liquid PU layer 4, in step 1; producing a semi-finished product in which the glass beads 3 are exposed by joining the secondary liquid PU layer 5 of the transfer film subject to the above step 1, to the backing material 6 and then subsequently separating the PET film 1 from the PE resin 2, in step 2; and placing a transparent or semitransparent TPU sheet 7 on the surface of the glass beads 3 of the semi-finished product subject to the above step 2, and then applying hot pressing or passing the resultant material through heating rollers, so that the liquid PU on the primary PU layer 4 to which heat and pressure was applied is activated to pass through the gaps among the glass beads 3 to the top and to be fixed to the transparent adhesive 7b formed on the transparent or semitransparent TPU sheet 7.

### BRIEF DESCRIPTION OF THE DRAWINGS

The features and advantages of the present invention will become apparent from reading the following detailed description of a preferred embodiment thereof illustrated with reference to the accompanying drawings, wherein:

FIGS. 1a to 1d show schematic processes according to a fundamental embodiment of the invention; and

FIG. 1e is a referential view of a finished product according to an application embodiment of the invention.

### DETAILED DESCRIPTION OF THE PREFERRED EMBODIMENT

When applying the invention as described hereinafter, it should be noted that the technology for producing a retro-reflective base film or retro-reflective sheet, transfer temperature, other material joining technology is known in the patents already registered by the inventor. It should also be noted that, since the diameter of glass beads, thickness of each layer to be formed and sheet thickness and the like can be varied depending on customer's requirements, particular specifications thereof will not be mentioned.

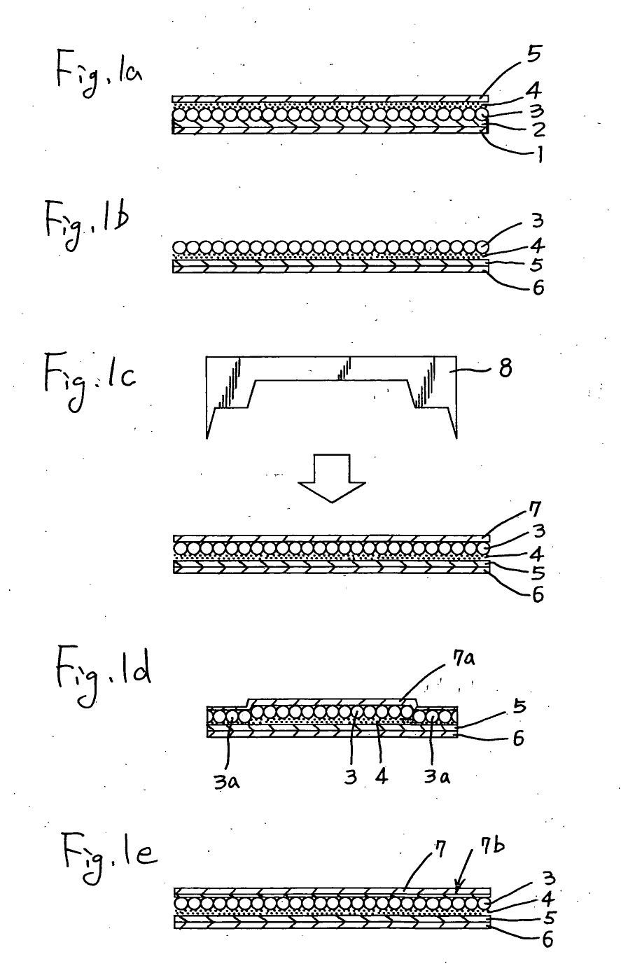

The FIGS. 1a to 1d of the inventions show schematically the embodiment of the invention, and do not include the process for using apparatuses already known. On the basis of the principle, the invention will be described hereinafter. First, a primary liquid PU layer 4 is formed for fixing a TPU sheet on the surface of the glass beads 3 of a conventional base film a comprising a PET film 1, PE resin 2 and glass beads 3, and, at the same time, a secondary liquid PU layer 5 is formed for fixing the backing material subsequently on the primary liquid PU layer 4, to produce a transfer film, in step 1 (FIG. 1a).

In this case, it is desirable that the secondary liquid PU layer 5 is formed before the primary liquid PU layer 4 is completely dried, but the condition is not compulsory. Subsequently, the backing material 6 is joined before the secondary liquid PU layer 5 of the transfer film subject to the step 1 is completely dried, and the PET film 1 is then separated from the PE resin 2 thereby to produce a semi-finished product in which the glass beads are exposed, in step 2 (FIG. 1b).

Subsequently, after placing a transparent or semitransparent TPU sheet 7 or a TPU sheet having a transmissible color or a TPU sheet having graphics as the case may be, on the surface of the glass beads 3 of the semi-finished product subject to the above step 2, high-frequency molding or cutting is applied by means of a high-frequency molding and cutting mold 8 (FIG. 1c).

With the process as shown in FIG. 1d, the glass bead layer 3a placed on both sides of the TPU sheet 7a to which heat and pressure was applied slightly descends. In this case, while the liquid PU on the primary liquid PU layer 4 is heated and thus activated, it passes through the gaps among the glass beads 3a to the top so that it is fixed to the transparent or semitransparent TPU sheet 7a. The process then ends and the embodiment of the invention is thus completed.

Here, if the backing material 6 is textile, leather, or other flexible material, the product at the completion step of the invention can be another new backing material. Of course, the backing material 6 may be anything including a hard plate body, metal, stone, etc.

Thereafter, referring to FIG. 1e showing the state of an product produced through the application embodiment of the invention, the same process as the basic embodiment is carried out to step 2 but the last step is different. That is, after placing a transparent or semitransparent TPU sheet 7 on the surface of the glass beads 4 of the semi-finished product subject to the above step 2 in the basic embodiment, the whole product is subject to hot pressing or is passed through heating rollers so that the liquid PU on the primary liquid PU layer 4 to which heat and pressure was applied is activated. The liquid PU then passes through the gaps among the entire glass beads 3 to the top to cause the liquid PU to be fixed to the transparent adhesive 7b formed on the transparent or semitransparent TPU sheet 7. Such an application embodiment does not induce high-frequency adhesion by applying pressure to some part, by means of a high-frequency molding and cutting mold 8, but can be carried out by means of a method of hot-pressing or passing the material through heating rollers. As shown in FIG. 1d, this embodiment is characterized in that the right and left parts of the product are not pressed to be flat, but the whole thickness of the finished product is made the same. To be described for reference, the conventional urethane adhesive is suddenly hardened because a hardener is used therein, so that it cannot be activated although heat is applied, and it cannot thus be used in the invention.

The inventive product obtained as described above settles and solves disadvantages and problems of conventional retro-reflective sheets because the TPU sheet 7a (7) is exposed in the air and other components are protected between the backing material 6 and the TPU sheet 7a (7). In addition, the inventive product is excellent in physical flexibility and durability, change resistance, resistance to ultraviolet rays, water resistance, weather resistance, salt resistance, solvent resistance and adhesiveness. Since the TPU sheet 1 is used as a surface protective means that allows easy secondary working, such as pressing or high-frequency molding, the sheet can be used as a safe product excellent in durability without lowering luminance although it is modified into any shape to produce an article.

The inventive product can be produced and used at cheaper prices and with lighter weight as compared to conventional sheets, even in the fields of traffic sign plates, traffic guide pates as well as clothes, decorations, safety products, shoes, etc. It was seen that, without removal of the glass beads, the inventive product can be easily and conveniently cleaned with water and can be subject to pressing, high-frequency molding, sewing, adhesion, etc. without causing any problems.

In addition, it is apparent to those skilled in the art that an aluminum vacuum coating layer is formed on the glass beads 3 of the base film a when carrying out the invention. Such a technique is already considered as a general technology in the field of the art and it is also apparent that using glass beads on which the aluminum vacuum coating layer is formed falls under the technical scope of the invention.

From the foregoing description, it will be observed that various modifications and changes can be made without departing from the true sprit and scope of the present invention. It should be understood that the foregoing description is intended to illustrate and not to limit the scope of the invention as defined by the claims.

What is claimed is:

1. A method of producing a retro-reflective product having a transparent protective film on the whole surface thereof, comprising the steps of:
A. producing a transfer film by forming a primary PU layer (4) for fixing a TPU sheet on the surface of glass beads (3) of a conventional base film (a) consisting of a PET film (1), PE resin (2) and the glass beads, and, at the same time, by forming a secondary liquid PU layer (5) for fixing backing material subsequently on the primary liquid PU layer (4), in step A;
B. producing a semi-finished product in which the glass beads (3) are exposed by joining the secondary liquid PU layer (5) subject to step A, to the backing material (6) and then subsequently separating the PET film (1) from the PE resin 2; and
C. placing a transparent or semitransparent TPU sheet (7) on the surface of the glass beads (3) of the semi-finished product subject to step B, and then carrying out high-frequency molding and cutting by means of a high-frequency molding and cutting mold (8), so that, while the liquid PU on the primary liquid PU layer (4) placed on both sides of the TPU sheet (7a) is activated to which heat and pressure was applied, the activated liquid PU passes through gaps among the glass beads 3a thereby to be fixed to the transparent or semitransparent TPU sheet 7a on top.

2. A method of producing a retro-reflective product having a transparent protective film on the whole surface thereof, comprising the steps of:
A. producing a transfer film by forming a primary PU layer (4) for fixing a TPU sheet on the surface of glass beads (3) of a conventional base film a consisting of a PET film (1), PE resin (2) and the glass beads (3), and, at the same time, by forming a secondary liquid PU layer (5) for fixing backing material subsequently on the primary liquid PU layer (4), in step A;
B. producing a semi-finished product in which the glass beads (3) are exposed by joining the secondary liquid PU layer (5) of the transfer film subject to step A, to the backing material (6) and then subsequently separating the PET film (1) from the PE resin (2); and
C. placing a transparent or semitransparent TPU sheet (7) on the surface of the glass beads (3) of the semi-finished product subject to the above step (2), and then applying hot pressing or passing the resultant material through heating rollers, so that the liquid PU on the primary PU layer (4) to which heat and pressure was applied is activated to pass through the gaps among the glass beads (3) to the top and to be fixed to the transparent adhesive (7b) formed on the transparent or semitransparent TPU sheet (7).
